(19) United States
(12) Patent Application Publication
(10) Pub. No.: US 2024/0316795 A1
(43) Pub. Date: Sep. 26, 2024

(54) ROBOTIC WRIST WITH MULTIPLE DEGREES OF FREEDOM

(71) Applicant: Sanctuary Cognitive Systems Corporation, Vancouver (CA)

(72) Inventors: Matthew Hill, Vancouver (CA); Hessam Maleki, Burnaby (CA); Connor Richard Shannon, Vancouver (CA); Seymur Dadashov, Richmond (CA); James Zhong Sheng Liu, Burnaby (CA)

(21) Appl. No.: 18/610,622

(22) Filed: Mar. 20, 2024

Related U.S. Application Data
(60) Provisional application No. 63/453,574, filed on Mar. 21, 2023.
(60) Provisional application No. 63/453,587, filed on Mar. 21, 2023.

(51) Int. Cl. B25J 17/02; B25J 9/10; B25J 9/16; B25J 15/00; B25J 19/00

(52) U.S. Cl. CPC B25J 17/0266; B25J 9/106; B25J 9/1664; B25J 15/0009; B25J 19/0041

(57) ABSTRACT

A robotic wrist includes a wrist frame, a first actuator having a first actuator output, and a second actuator having a second actuator output. A first mechanical linkage includes a first input coupled to the first actuator output and a first output coupled to the wrist frame. A second mechanical linkage includes a second input coupled to the second actuator output and a second output coupled to the wrist frame. A rotational position of the first output about a first axis is responsive to a position of the first actuator output. A rotational position of the second output about a second axis that is transverse to the first axis is responsive to a different between a position of the first actuator output and a position of the second actuator output.

### CROSS-REFERENCE TO RELATED APPLICATIONS

This application claims the benefit of U.S. Provisional Application No. 63/453,574 filed on Mar. 21, 2023, and U.S. Provisional Application No. 63/453,587 filed on Mar. 21, 2023, the contents of which are incorporated herein by reference.

### FIELD

The field generally relates to articulated arms and in particular to articulated arms for humanoid robots.

### BACKGROUND

Robots are machines that can sense their environments and perform tasks autonomously or semi-autonomously or via teleoperation. A humanoid robot is a robot or machine having an appearance and/or character resembling that of a human. Humanoid robots can be designed to function as team members with humans in diverse applications, such as construction, manufacturing, monitoring, exploration, learning, and entertainment. Humanoid robots can be particularly advantageous in substituting for humans in environments that may be dangerous to humans or uninhabitable by humans.

There continues to be a need for a humanoid robot that can be easily integrated into diverse environments to assist or substitute for humans.

### SUMMARY

Disclosed herein are examples of a robotic wrist having multiple degrees of freedom. The robotic wrist can be coupled to an end effector and used to position the end effector in a three-dimensional space. The robotic wrist can form a segment of a robotic arm having multiple degrees of freedom.

In a representative example, a robotic wrist includes a wrist frame, a first actuator, a second actuator, a first mechanical linkage, and a second mechanical linkage. The first actuator has a first actuator output. The second actuator has a second actuator output. The first mechanical linkage includes a first input coupled to the first actuator output and a first output coupled to the wrist frame. The second mechanical linkage includes a second input coupled to the second actuator output and a second output coupled to the wrist frame. A rotational position of the first output about a first axis is responsive to a position of the first actuator output. A rotational position of the second output about a second axis that is transverse to the first axis is responsive to a difference between a position of the first actuator output and a position of the second actuator output.

In another representative example, a robotic arm includes a plurality of arm segments coupled together in series. A first arm segment of the plurality of arm segments includes a frame, a first actuator, a second actuator, a first mechanical linkage, and a second mechanical linkage. The first actuator has a first actuator output. The second actuator has a second actuator output. The first mechanical linkage includes a first input coupled to the first actuator output and a first output coupled to the frame. The second mechanical linkage includes a second input coupled to the second actuator output and a second output could to the frame. A rotational position of the first output about a first axis is responsive to a position of the first actuator output. A rotational position of the second output about a second axis that is transverse to the first axis is responsive to a difference between a position of the first actuator output and a position of the second actuator output.

In another representative example, a robot includes a robot torso, an end effector, and a robotic arm coupled to the robot torso and the end effector. The robotic arm includes a robotic wrist, which includes a wrist frame, a first actuator, a second actuator, a first mechanical linkage, and a second mechanical linkage. The first actuator has a first actuator output. The second actuator has a second actuator output. The first mechanical linkage includes a first input coupled to the first actuator output and a first output coupled to the wrist frame. The second mechanical linkage includes a second input coupled to the second actuator output and a second output coupled to the wrist frame and the end effector. A rotational position of the first output about a first axis is responsive to a position of the first actuator output. A rotational position of the second output about a second axis that is transverse to the first axis is responsive to a difference between a position of the first actuator output and a position of the second actuator output.

In another representative example, a robotic wrist includes a wrist frame, a first actuator, a second actuator, a first differential input, a second differential input, a first link set, and a second link set. The first actuator has a first actuator output defining a first axis. The second actuator has a second actuator output defining a second axis. The first differential input is coupled to the first actuator output and rotatable about the first axis in response to motion of the first actuator output. The second differential input is coupled to the second actuator output and rotatable about the second axis in response motion of the second actuator output. The first differential output is coupled to the wrist frame and rotatably supported about a third axis. The second differential output is coupled to the wrist frame and rotatably supported about the third axis and a fourth axis that is transverse to the third axis. The first link set couples the first differential input to the first differential output. The second link set couples the second differential input to the second differential output. A rotational position of the first differential output about the third axis is responsive to a rotational position of the first differential input about the first axis. A rotational position of the second differential output about the fourth axis is responsive to a difference between a rotational position of the first differential input about the first axis and a rotational position of the second differential input about the second axis.

In another representative example, a robotic arm includes a plurality of arm segments coupled together in series by movable joints. A first arm segment of the plurality of segments includes a frame, a first actuator, a second actuator, a first differential input, a second differential input, a first link set, and a second link set. The first actuator has a first actuator output defining a first axis. The second actuator has a second actuator output defining a second axis. The first differential input is coupled to the first actuator output and rotatable about the first axis in response to motion of the first actuator output. The second differential input is coupled to the second actuator output and rotatable about the second axis in response motion of the second actuator output. The first differential output is coupled to the frame and rotatably supported about a third axis. The second differential output is coupled to the frame and rotatably supported about the third axis and a fourth axis that is transverse to the third axis. The first link set couples the first differential input to the first differential output. The second link set couples the second differential input to the second differential output. A rotational position of the first differential output about the third axis is responsive to a rotational position of the first differential input about the first axis. A rotational position of the second differential output about the fourth axis is responsive to a difference between a rotational position of the first differential input about the first axis and a rotational position of the second differential input about the second axis.

In another representative example, a robot includes a robot torso and a robotic arm coupled to the robot body. The robotic arm includes a plurality of arm segments coupled together in series by movable joints. A first arm segment of the plurality of segments includes a frame, a first actuator, a second actuator, a first differential input, a second differential input, a first link set, and a second link set. The first actuator has a first actuator output defining a first axis. The second actuator has a second actuator output defining a second axis. The first differential input is coupled to the first actuator output and rotatable about the first axis in response to motion of the first actuator output. The second differential input is coupled to the second actuator output and rotatable about the second axis in response motion of the second actuator output. The first differential output is coupled to the frame and rotatably supported about a third axis. The second differential output is coupled to the frame and rotatably supported about the third axis and a fourth axis that is transverse to the third axis. The first link set couples the first differential input to the first differential output. The second link set couples the second differential input to the second differential output. A rotational position of the first differential output about the third axis is responsive to a rotational position of the first differential input about the first axis. A rotational position of the second differential output about the fourth axis is responsive to a difference between a rotational position of the first differential input about the first axis and a rotational position of the second differential input about the second axis.

In another representative example, a method of positioning an end effector in a three-dimensional space includes receiving or accessing a first target rotational position of the end effector relative to a first axis and receiving or accessing a second target rotational position of the end effector relative to a second axis that is transverse to the first axis. The method includes determining a first actuator position for a first actuator having a first actuator output coupled to an input of a first mechanical linkage based on the first target rotational position, wherein an output of the first mechanical linkage is coupled to the end effector. The method includes determining a second actuator position for a second actuator having a second actuator output coupled to an input of a second mechanical linkage based on a difference between the first rotational position and the second rotational position, wherein an output of the second mechanical linkage is coupled to the end effector. The method includes respectively controlling the first actuator and the second actuator to the respective first actuator position and the second actuator position to rotate the end effector to the first target rotational position about the first axis and the second target rotational position about the second axis.

In another representative example, a robotic wrist includes a wrist frame, a first actuator having a first actuator output, a second actuator having a second actuator output, a first mechanical linkage comprising a first input coupled to the first actuator output and a first output coupled to the wrist frame, and a second mechanical linkage comprising a second input coupled to the second actuator output and a second output coupled to the wrist frame. The first mechanical linkage includes a first four-bar linkage. The second mechanical linkage includes a second four-bar linkage and a spherical linkage coupled to the second four-bar linkage.

### BRIEF DESCRIPTION OF THE DRAWINGS

FIG. 1 is a front view of an example robot on a mobile base.

FIG. 2A is a perspective view of a robotic wrist.

FIG. 2B is a top view of the robotic wrist shown in FIG. 2A.

FIG. 2C is a side view of the robotic wrist shown in FIG. 2A.

FIG. 2D is a cross-sectional view of the robotic wrist shown in FIG. 2C along line 2D-2D.

FIG. 2E is a cross-sectional view of the robotic wrist shown in FIG. 2B along line 2E-2E.

FIG. 2F is a perspective view of the robotic wrist shown in FIG. 2A with a partial cutaway.

FIG. 2G is a perspective view of a differential mechanism of the robotic wrist shown in FIG. 2A.

FIG. 2H is a rotated view of the differential mechanism shown in FIG. 2G.

FIG. 2I illustrates four-bar mechanisms of the robotic wrist on the side view of the robotic wrist shown in FIG. 2C.

FIGS. 2J and 2K show the four-bar mechanisms illustrated in FIG. 2I.

FIGS. 3A-3D illustrate an end effector at different flexion and abduction positions relative to the robotic wrist shown in FIG. 2A.

FIG. 4 is an exploded assembly view of the robotic wrist shown in FIG. 2A.

### DETAILED DESCRIPTION

### General Considerations

For the purpose of this description, certain specific details are set forth herein in order to provide a thorough understanding of disclosed technology. In some cases, as will be recognized by one skilled in the art, the disclosed technology may be practiced without one or more of these specific details, or may be practiced with other methods, structures, and materials not specifically disclosed herein. In some instances, well-known structures and/or processes associated with robots have been omitted to avoid obscuring novel and non-obvious aspects of the disclosed technology.

All the examples of the disclosed technology described herein and shown in the drawings may be combined without any restrictions to form any number of combinations, unless the context clearly dictates otherwise, such as if the proposed combination involves elements that are incompatible or mutually exclusive. The sequential order of the acts in any process described herein may be rearranged, unless the context clearly dictates otherwise, such as if one act or operation requests the result of another act or operation as input.

In the interest of conciseness, and for the sake of continuity in the description, same or similar reference characters may be used for same or similar elements in different figures, and description of an element in one figure will be deemed to carry over when the element appears in other figures with the same or similar reference character, unless stated otherwise. In some cases, the term “corresponding to” may be used to describe correspondence between elements of different figures. In an example usage, when an element in a first figure is described as corresponding to another element in a second figure, the element in the first figure is deemed to have the characteristics of the other element in the second figure, and vice versa, unless stated otherwise.

The word “comprise” and derivatives thereof, such as “comprises” and “comprising”, are to be construed in an open, inclusive sense, that is, as “including, but not limited to”. The singular forms “a”, “an”, “at least one”, and “the” include plural referents, unless the context dictates otherwise. The term “and/or”, when used between the last two elements of a list of elements, means any one or more of the listed elements. The term “or” is generally employed in its broadest sense, that is, as meaning “and/or”, unless the context clearly dictates otherwise. When used to describe a range of dimensions, the phrase “between X and Y” represents a range that includes X and Y. As used herein, an “apparatus” may refer to any individual device, collection of devices, part of a device, or collections of parts of devices.

The term “coupled” without a qualifier generally means physically coupled or lined and does not exclude the presence of intermediate elements between the coupled elements absent specific contrary language. The term “plurality” or “plural” when used together with an element means two or more of the element. Directions and other relative references (e.g., inner and outer, upper and lower, above and below, and left and right) may be used to facilitate discussion of the drawings and principles but are not intended to be limiting and are within the context of the orientation of the drawings, unless stated otherwise.

The headings and Abstract are provided for convenience only and are not intended, and should not be construed, to interpret the scope or meaning of the disclosed technology.

### Example I

### Overview

Described herein is a robotic wrist with multiple degrees of freedom. The robotic wrist can form a segment of a robotic arm with multiple degrees of freedom. The robotic arm including the robotic wrist can be attached to a robot body, which can be a humanoid torso or non-humanoid robot body. The robotic wrist can be connected to an end effector and used to position the end effector in a three-dimensional space. In some examples, the robotic wrist uses a differential mechanism driven by two actuators to effect two degrees of freedom. A difference between the outputs of the two actuators controls one degree of freedom (e.g., abduction). A commonality between the outputs of the two actuators controls another degree of freedom (e.g., flexion).

### Example II

### Example Humanoid Robot

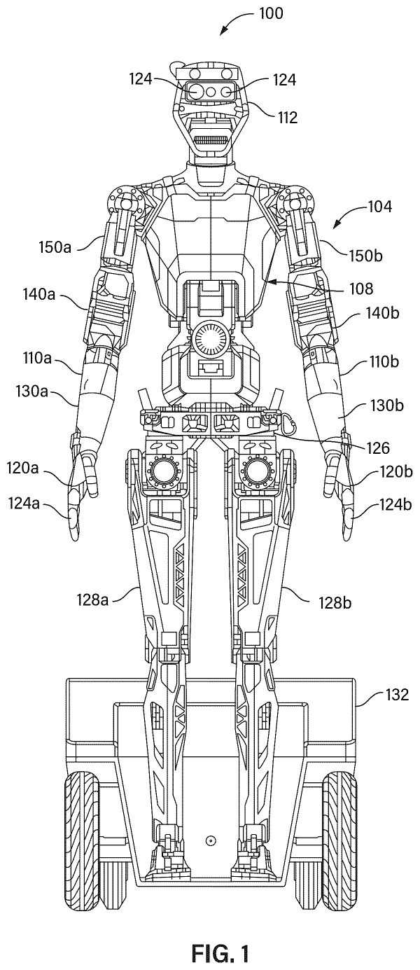

FIG. 1 illustrates an example robot 100 having a humanoid form. The robot 100 includes a robot body 104 having a robotic torso 108, a robotic head 112 coupled to the top of the robotic head 112, robotic arms 110a, 110b coupled to opposite sides of the robotic torso 108, and end effectors (or robotic hands) 120a, 120b coupled to the ends of the robotic arms 110a, 110b. The robotic head 112 can include one or more robotic vision sensors 124 (e.g., cameras), which the robot 100 can use to collect information from its environment.

The robotic arms 110a, 110b can include robotic shoulders 150a, 150b coupled to the robotic torso 108 by movable joints, robotic elbows 140a, 140b coupled to the robotic shoulders 150a, 150b by movable joints, and robotic wrists 130a, 130b coupled to the robotic elbows 140a, 140b by movable joints. The end effectors 120a, 120b are coupled to the robotic wrists 130a, 130b and can include one or more digits 124a, 124b (or articulable members), which the robot 100 can use to interact with objects in the environment or to make gestures.

One or more robotic legs (e.g., robotic legs 128a, 128b) can be coupled to the robotic torso 108 by a robotic hip 126. In the illustrated example, the robotic legs 128a, 128b are attached to a mobile base 132 (e.g., a wheeled platform). In some examples, the robot 100 can be bipedal (e.g., the robot 100 can walk with the robotic legs 128a, 128b). In other examples, the robot 100 may not have robotic legs and may still be considered to have a humanoid form. In these other examples, the robotic torso 108 may include a base mounted on a pedestal, which can be attached to a mobile base (such as a wheeled platform).

### Example III

### Example Robotic Wrist

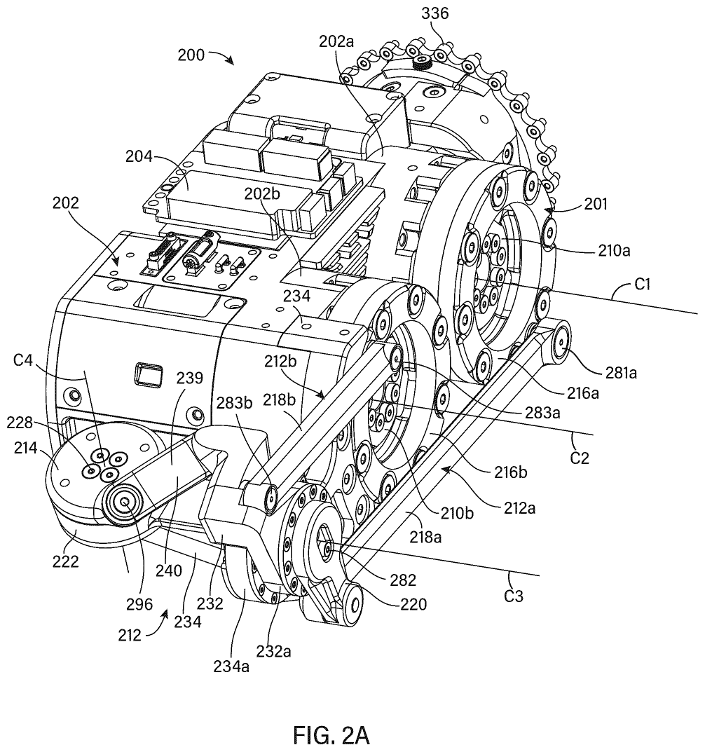

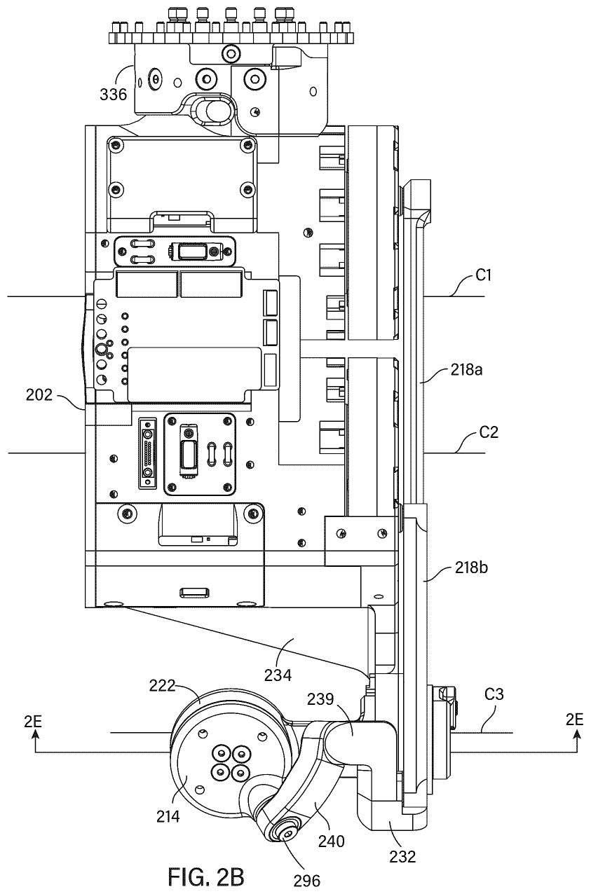

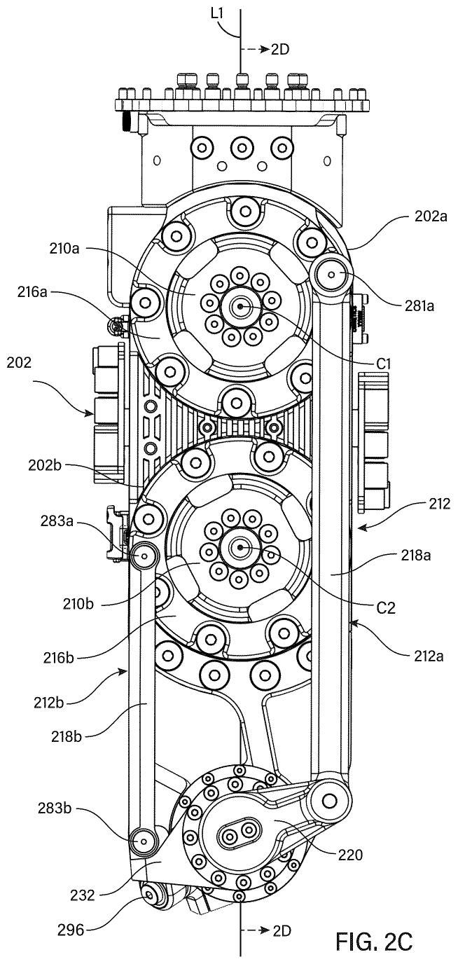

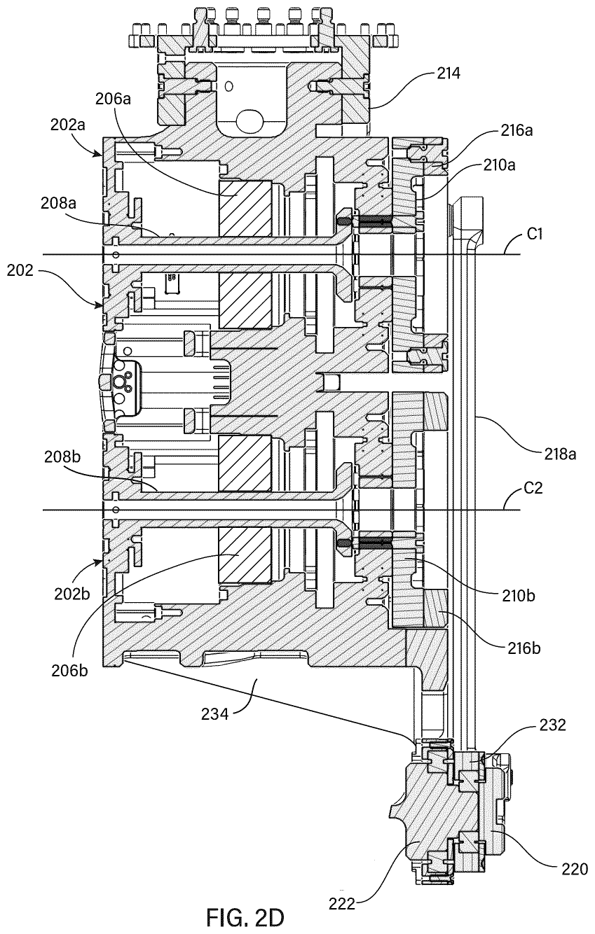

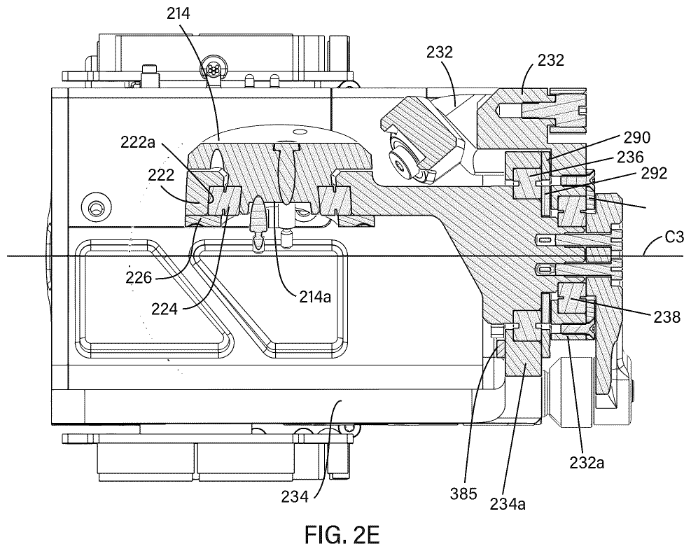

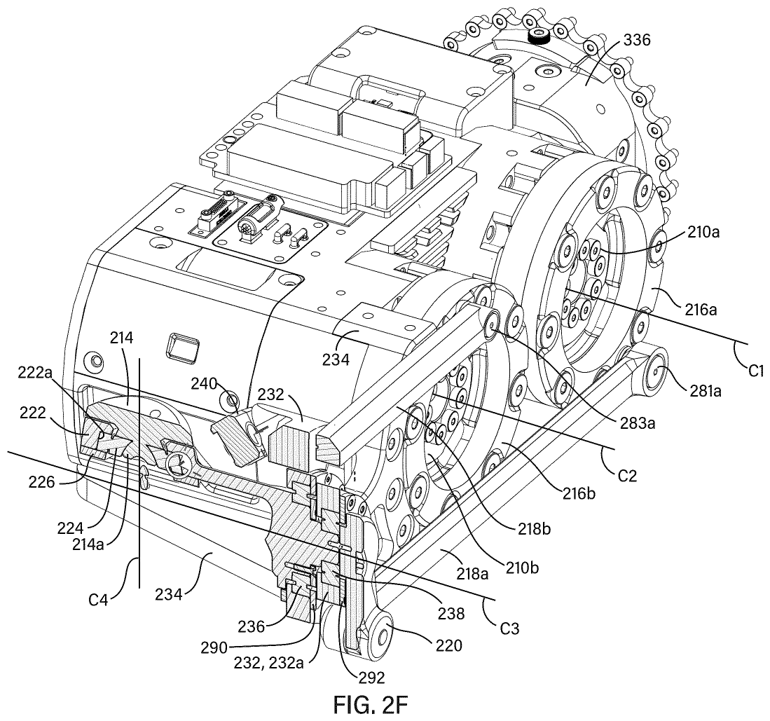

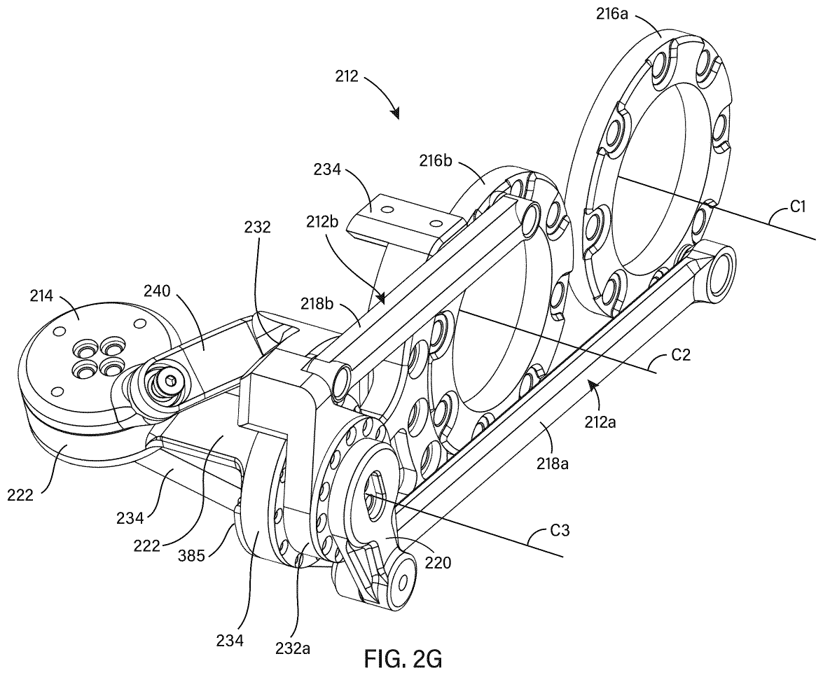

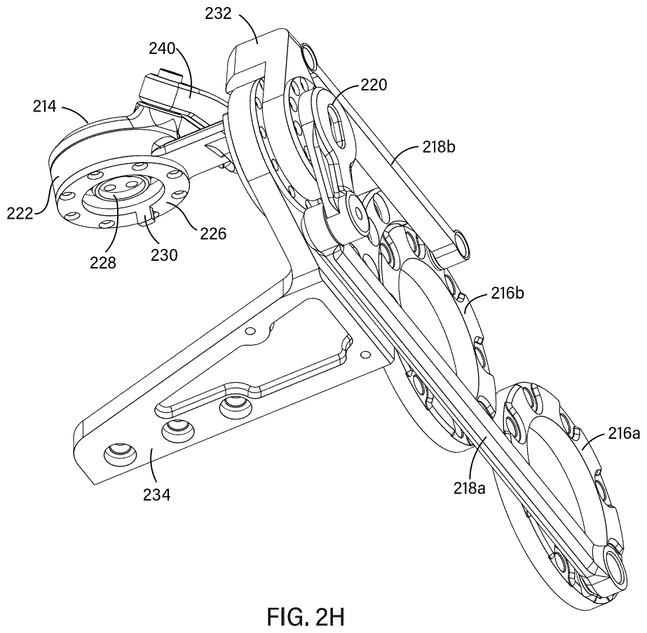

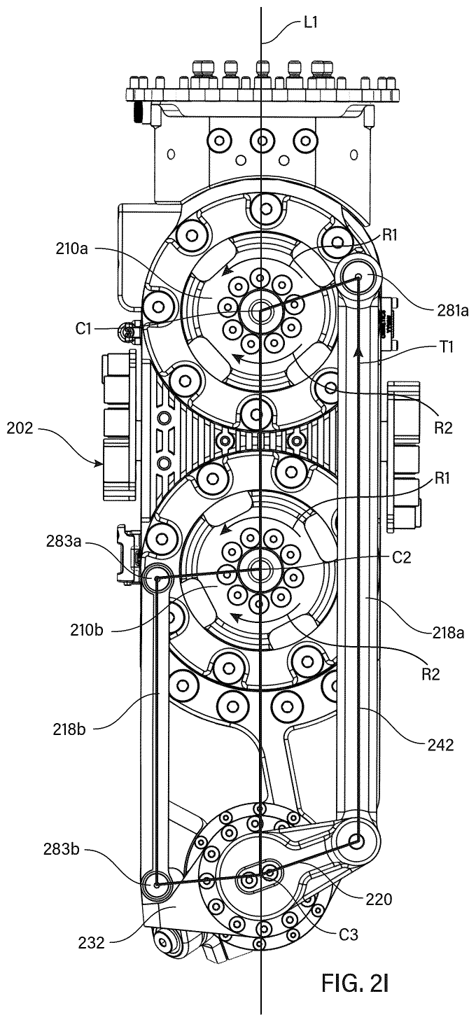

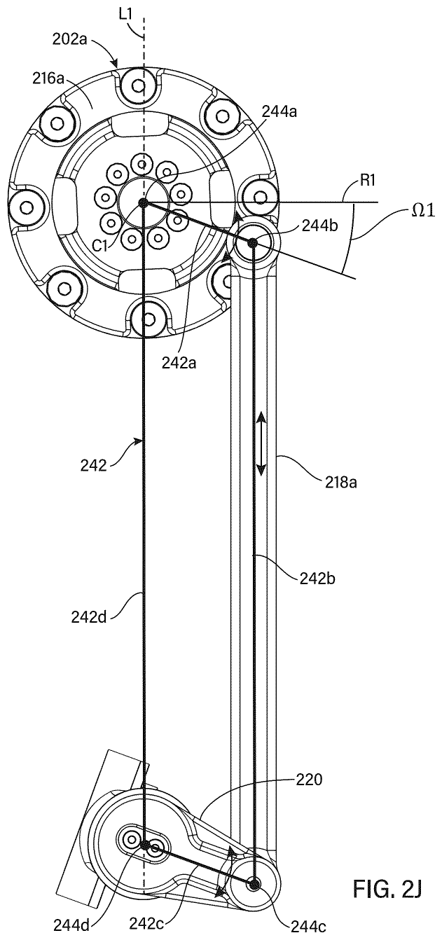

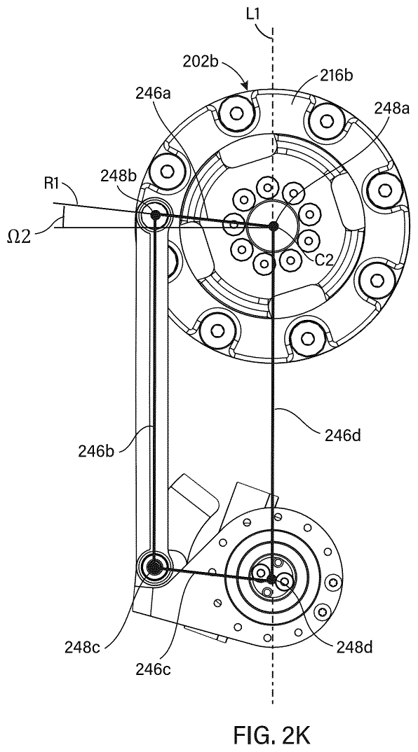

FIGS. 2A-2I illustrate an example robotic wrist 200 to which an end effector can be attached. The robotic wrist 200 can form a segment of a robotic arm (such as any of the robotic arms 110a, 110b shown in FIG. 1). For example, any of the robotic wrists 130a, 130b shown in FIG. 1 can be implemented with the robotic wrist 200.

In some examples, the robotic wrist 200 includes a differential drive 201 coupled to a wrist frame 234. The differential drive 201 can include a first actuator 202a, a second actuator 202b, and a differential mechanism 212 driven by the first actuator 202a and the second actuator 202b. The differential mechanism 212 can transfer motion of the first actuator 202a and the second actuator 202b to a first output member (e.g., a flexion output arm 220) and a second output member (e.g., an abduction spherical output 214). In some examples, at least one of the output members can include attachment features for an end effector.

In some examples, the first actuator 202a and the second actuator 202b can be rotary actuators. For example, the first actuator 202a and the second actuator 202b can include electric motors (e.g., DC or AC motors, stepper motors, servo motors, or selsyn synchronous rotation motors), hydraulic motors, or pneumatic motors. The actuators 202a, 202b can have associated drivers 204 that receive controls for operation of the motors. In some examples, as shown more clearly in FIG. 2D, the actuators 202a, 202b can include motors 206a, 206b and output shafts 208a, 208b coupled to the output motion of the motors 206a, 206b (e.g., the output shafts 208a, 208b can be coupled to the rotors of the motors 206a, 206b).

The output shafts 208a, 208b define rotational axes C1, C2 of the actuators 202a, 202b. In some examples, the actuators 206a, 206b are arranged such that the rotational axes C1, C2 are parallel. In some examples, torque sensors 210a, 210b can be coupled to the output shafts 208a, 208b of the actuators 202a, 202b to measure the output torque of the actuators 202a, 202b. The measured torque can be used as feedback control for the motors 206a, 206b. In some examples, the actuators 202a, 202b can include encoders (not shown separately) that measure a characteristic of the output motion of the actuators 202a, 202b, such as position or speed of the output shafts 208a, 208b. The encoder output can be used as feedback control for the motors 206a, 206b.

In some examples, as shown in FIG. 2A, the first actuator 202a, the second actuator 202b, and the drivers 204 can be integrated into a single package 202 (which can also be referred to herein as “dual actuator”). For example, the actuators 202a, 202b and the drivers 204 can be disposed or mounted in a common housing (or frame) to form the dual actuator 202. By integrating the first actuator 202a and the second actuator 202b into a common housing, the rotational alignment of the actuators 202a, 202b may be better maintained (e.g., the rotational axes C1, C2 can be maintained in parallel). In addition, the dual actuator 202 can be made compact so as to reduce the overall size of the robotic wrist 200 and avoid a robotic wrist with a bulky (“Popeye-like”) appearance. The dual actuator 202 (or the common housing of the actuators 202a, 202b) can be attached to the wrist frame 234.

The actuators 202a, 202b can drive the differential mechanism 212 to effect two degrees of freedom (e.g., flexion and abduction). In some examples, the differential mechanism 212 transmits the output motion of the actuators 202a, 202b to the abduction spherical output 214 and the flexion output arm 220 via two separate mechanical linkages 212a, 212b. In some examples, the differential mechanism 212 is configured such that when the positions (e.g., angles) of the actuators 202a, 202b are the same, the flexible output arm 220 is rotated about the rotational axis C3 by an amount related to the position of the first actuator 202a. In some examples, the differential mechanism 212 is configured such that when the positions (e.g., angles) of the actuators 202a, 202b are not the same, the abduction spherical output 214 is rotated about the rotational axis C4 by an amount related to the difference between the positions of the first actuator 202a and the second actuator 202b.

In some examples, the motion of the flexible output arm 220 about the axis C3 is coupled to the abduction spherical output 214 such that when the flexible output arm 220 is rotated about the rotational axis C3, the abduction spherical output 214 is also rotated about the rotational axis C3. In this manner, the end effector can be coupled to only the abduction spherical output 214 to achieve flexion and/or abduction of the end effector and positioning of the end effector in a three-dimensional space. The abduction spherical output 214 can include attachment features (e.g., holes 228 that receive fasteners) for attaching an end effector (such as the end effector 124a, 124b in FIG. 1) or an end effector interface (such as a quick coupling) to the abduction spherical output 214.

A first mechanical linkage 212a of the differential mechanism 212 can include a flexion input 216a coupled to the output motion of the first actuator 202a (e.g., by attaching the flexion input 216a to the torque sensor 210a at the output of the first actuator 202a or directly to the output shaft 208a of the first actuator 202a). In some examples, the flexion input 216a can have an axial axis that is aligned with the rotational axis C1 of the first actuator 202a such that the flexion input 216a has a rotational center that coincides with the rotational axis C1. In some examples, the flexion input 216a can be in the form of a ring plate with openings to receive fasteners (e.g., fasteners that attach the flexion input 216a to the torque sensor 210a or output shaft 208a).

A second mechanical linkage 212b of the differential mechanism 212 can include an abduction input 216b coupled to the output motion of the second actuator 202b (e.g., by attaching the abduction input 216b to the torque sensor 210b at the output of the second actuator 202b or directly to the output shaft 208b of the second actuator 202b). In some examples, the abduction input 216b can have an axial axis that is aligned with the rotational axis C2 of the second actuator 202b such that the abduction input 216b has a rotational center that coincides with the rotational axis C2. In some examples, the abduction input 216b can be in the form of a ring plate with openings to receive fasteners (e.g., fasteners that attach the abduction input 216b to the torque sensor 210b or output shaft 208b).

The first mechanical linkage 212a can include a flexion link 218a having a first end portion coupled to the flexion input 216a such that the output motion of the first actuator 202a can cause linear displacement of the flexion link 218a (e.g., in a direction parallel to an axial axis L1 of the robotic wrist 200, which is an axis that is transverse to the axes C1, C2 as shown in FIGS. 2B and 2C). In some examples, the flexion link 218a can be coupled to the flexion input 216a by a movable joint (e.g., a rotary joint including a cam follower bearing 281a) such that rotary motion of the first actuator 202a about the rotational axis C1 can be transferred to linear displacement of the flexion link 218a via the flexion input 216a. The second end portion of the flexion link 218 can be attached to the flexion output arm 220 by a movable joint (e.g., a rotary joint including a cam follower 283a).

The differential mechanism 212 can include a compound motion plate 222 rotatably supported on the wrist frame 234. The compound motion plate 222 can have an axial axis that defines the rotational axis C3. In some examples, the compound motion plate 222 can be oriented such that the rotational axis C3 is parallel to the rotational axes C1, C2. In some examples, the flexion output arm 220 can be fixedly coupled to a first end portion of the compound motion plate 222 (e.g., using one or more fasteners 282). In this manner, the compound motion plate 222 can rotate about the axis C3 when the flexion output arm 220 is displaced by movement of the flexion link 218a.

The abduction spherical output 214 can be rotatably coupled to a second end portion of the compound motion plate 222. For example, as shown in FIGS. 2E and 2F, the abduction spherical output 214 can be mounted on the compound motion plate 222 and can include an end portion 214a that extends into an opening 222a in the second end portion of the compound plate 222. A bearing 224 (e.g., a crossed roller bearing) can be arranged in the opening 222a and between the compound motion plate 222 and the end portion 214a to support rotation of the abduction spherical output 214 relative to the compound motion plate 222. Since the abduction spherical output 214 is coupled to the compound motion plate 222, the abduction spherical output 214 can rotate about the axis C3 when the compound motion plate 222 rotates about the axis C3.

As shown more clearly in FIGS. 2C and 2G, the second mechanical linkage 212b can include an abduction link 218b having a first end portion coupled to the abduction input 216b such that the output motion of the second actuator 202b can cause linear displacement of the abduction link 218b (e.g., in a direction parallel to the axial axis L1). In some examples, the abduction link 218b can be coupled to the abduction input 216b by a movable joint (e.g., a rotary joint including a cam follower 283b) such that rotary motion of the second actuator 202b about the rotational axis C2 can be transferred to linear displacement of the abduction link 218b through the abduction input 216b.

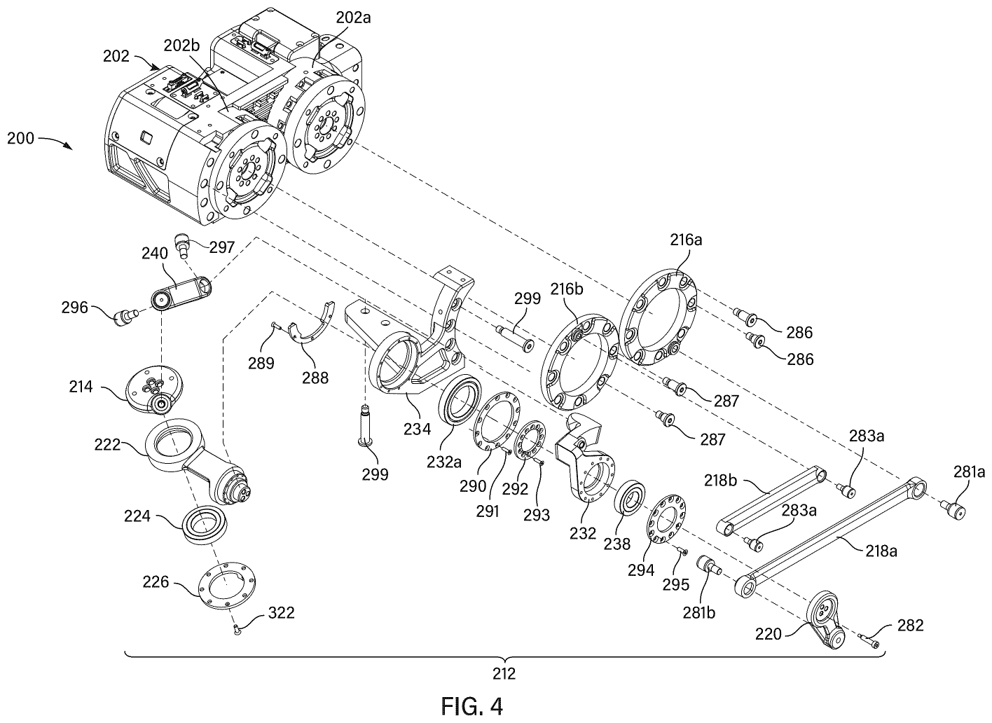

The second mechanical linkage 212b can include a spherical linkage 239 (shown in FIGS. 2A and 2B) to transfer linear displacement of the abduction link 218b to rotation of the abduction spherical output 214 about the rotational axis C4. In some examples, the spherical linkage 239 can include a spherical linkage input 232 coupled to a second end portion of the abduction link 218b by a movable joint (e.g., a rotary joint including a cam follower 283b). The spherical linkage 239 can include a spherical link 240 coupled at a first end to the spherical linkage input 232 via a movable joint (e.g., a rotary joint including a cam follower 297 shown in FIG. 4) and coupled at a second end to the abduction spherical output 214 via a movable joint (e.g., a rotary joint including a cam follower 296).

In some examples, the spherical linkage input 232 can be rotatably supported relative to the compound motion plate 222. For example, as shown in FIGS. 2E and 2F, the wrist frame 234 can include a flange portion 234a that is disposed adjacent to a flange portion 232a of the spherical linkage input 232. In some examples, the flange portion 232a can be positioned between the flexion output arm 220 and the flange portion 234a. The flange portions 232a, 234a can have central openings that are axially aligned along the rotational axis C3 and that receive the first end portion of the compound motion plate 222 to which the flexion output arm 220 is attached. Bearings 236, 238 can be arranged in the central openings of the flange portions 232a, 234a, between the first end portion of the compound motion plate 222 and the inner wall of the flange portions 232a, 234a, to support relative rotation between the compound motion plate 222 and the spherical linkage input 232 about the rotational axis C3.

In some examples, a mechanical stop member 226 can be attached to the second end portion of the compound motion plate 222 to limit rotation of a component coupled to the abduction spherical output 214 about the axis C4. The mechanical stop member 226 can include a tab 230 (shown in FIG. 2H) that can selectively engage a wall of a slot in an attachment interface of an end effector (or other component) coupled to the abduction spherical output 214. In other examples, the mechanical stop member 226 can include a slot to selectively receive a tab in in an attachment interface of an end effector (or other component). Rotation of the abduction spherical output 214 can be limited by selective engagement of the tab and slot (or other cooperating stop surfaces).

In some examples, as illustrated in FIGS. 2I and 2J, the first mechanical linkage 212a includes a first four-bar mechanism (or four-bar linkage) 242. As shown in FIG. 2J, the first four-bar mechanism 242 includes an input link 242a extending from a pivot 244a at the rotational center of the flexion input 216a to a pivot 244b at a joint between the flexion input 216a and the flexion link 218a, a coupler link 242b extending from the pivot 244b to a pivot 244c at a joint between the flexion link 218a and the flexion output arm 220, an output link 242c extending from the pivot 244c to a pivot 244d at a rotational center of a joint between the flexion output arm 220 and the compound motion plate 222, and a fixed link 242d extending from the pivot 244d to the pivot 244a. The pivots 244a, 244d are fixed relative to the wrist frame (234 in FIGS. 2A and 2B), while the pivots 244b, 244c are movable relative to the wrist frame. The links 242a, 242b, 242c, 242d form a parallelogram. The coupler link 242b corresponds to the flexion link 218a, and the output link 242c corresponds to the flexion output arm 220. The coupler link 242b (or the flexion link 218a) can have an angle Ω₁ (which can be referred to herein as flexion input angle) relative to a reference axis R1 that is orthogonal to axes L1 and C1. The flexion input angle Ω₁ depends on the position (e.g., angle) of the first actuator 202a.

In some examples, as illustrated in FIGS. 2I and 2K, the second mechanical linkage 212b includes a second four-bar mechanism (or four-bar linkage) 246. As shown in FIG. 2K, the second four-bar mechanism 246 includes an input link 246a extending from a pivot 248a at the rotational center of the abduction input 216b to a pivot 248b at a joint between the abduction input 216b and the abduction link 218b, a coupler link 246b extending from the pivot 248b to a pivot 248c at a joint between the abduction link 218b and the spherical linkage input 232, an output link 246c extending from the pivot 248c to a pivot 248d at a rotational center of a joint between the spherical linkage input 232 and the compound motion plate 222, and a fixed link 246d extending from the pivot 248d to the pivot 248a. The links 246a, 246b, 246c, 246d form a parallelogram. The pivots 248a, 248d are fixed relative to the wrist frame (234 in FIGS. 2A and 2B). The coupler link 246b corresponds to the abduction link 218b, and the output link 246c corresponds to the spherical linkage input 232. The coupler link 246b (or the abduction link 218b) can have an angle Ω₂ (which can be referred to herein as abduction input angle) relative to a reference axis R2 that is orthogonal to the axes L1 and C2 (e.g., parallel to the axis R1 in FIG. 2J). The abduction input angle Ω₂ between depends on the rotational position of the second actuator 202b. The spherical linkage 239 (shown in FIGS. 2A and 2B) of the second mechanical linkage 212b is coupled to the second four-bar mechanism 242.

Returning to FIG. 2A, the differential mechanism 212 can output different movements (flexion, abduction, or a combination of flexion and abduction) depending on the positions of the first and second actuators 202a, 202b. The flexion angle and the abduction angle can be kinematically related according to the following expressions:

$${Ω}_{1} = θ \qquad ( 1 )$$

$${Ω}_{2} = θ + f ( φ ) \qquad ( 2 )$$

Where Ω₁ is the flexion input angle (which is dependent on the position of the first actuator 202a), Ω₂ is the abduction input angle (which is dependent on the position of the second actuator 202b), θ is the flexion angle (e.g., the rotational position of the flexion output arm 220 relative to the rotational axis C3), and φ is the output abduction angle (e.g., the rotational position of the abduction spherical output 214 relative to the axis C4). f(φ) is a function that is dependent on the abduction angle. The function f(φ) can be determined from measurements (e.g., by determining flexion and abduction angles for a range of actuator positions and fitting a function to the measurement data). Given a target flexion angle and a target abduction angle, the required flexion input angle and abduction input angle can be determined according to Equations (1) and (2).

By substituting Equation (1) into Equation (2), the following expression can be obtained:

$$f ( φ ) = {Ω}_{2} - {Ω}_{1} \qquad ( 3 )$$

From Equation (1), flexion angle θ is controlled by the flexion input angle Ω₁ (which is dependent on the position (e.g., angle) of the first actuator 202a). From Equation (3), abduction angle φ is controlled by a difference between the flexion input angle Ω₁ and the abduction input angle Ω₂ (or a difference between the positions of the first actuator 202a and the second actuator 202b).

When there is no difference between the flexion input angle and the abduction input angle (e.g., Ω₁=Ω₂), the four-bar mechanisms 242, 246 (shown in FIGS. 2J and 2K) of the mechanical linkages 212a, 212b are moving at the same angle or synchronously. When there is a difference between the flexion input angle and the abduction input angle, the four-bar mechanisms 242, 246 are moving at different angles or asynchronously. The difference in displacements of the output links of the four-bar mechanism 242, 246 in the asynchronous mode causes the spherical linkage 239 to rotate the abduction spherical output about the axis C4.

Table 1 summarizes possible movements that can be outputted from the differential mechanism 212 based on given values of flexion angle θ and abduction angle φ. In Table 1, a, b, c, and d represent nonzero values of angles. The values a, b, c, and d can be positive or negative depending on the direction of rotation.

TABLE 1

| | | | Flexion | Abduction | |
|---|---|---|---|---|---|
| | Flexion | Abduction | Input Angle, | Input Angle, | Resultant |
| Mode | Angle, θ | Angle, φ | Ω₁ | Ω₂ | Movement |
| 1 | a | 0 | a | a + f(0) | Flexion |
| | | | | | (Abduction) |
| 2 | 0 | b | 0 | f(b) | Pure |
| | | | | | Abduction |
| 3 | c | d | c | c + f(d) | Flexion and |
| | | | | | Abduction |

In some examples, the differential drive 201 can be configured such that the abduction function f(φ)=θ when φ=0. In this case, when flexion angle is nonzero and abduction angle is zero, the abduction input angle will be the same as the flexion input angle, resulting in a pure flexion movement with twice the amount of force at the output (e.g., each of the four-bar mechanisms contributes to the output force). Table 2 summarizes possible movements that can be outputted from the differential drive 201 with the assumption that the abduction function f(φ)=θ when φ=0. As in the example shown in Table 1, a, b, c, and d represent nonzero values of angles.

TABLE 2

| | | | Flexion | Abduction | | |
|---|---|---|---|---|---|---|
| | Flexion | Abduction | Input | Input | Resultant | Kinematic |
| Mode | Angle, θ | Angle, φ | Angle, Ω₁ | Angle, Ω₂ | Movement | Chains |
| 1 | a | 0 | a | a | Pure Flexion | Synchronous |
| 2 | 0 | b | 0 | f(b) | Pure | Asynchronous |
| | | | | | Abduction | |
| 3 | c | d | c | c + f(d) | Flexion and | Asynchronous |
| | | | | | Abduction | |

In Mode 1 of Table 2, the flexion input angle and the abduction input angle are the same, which means that the four-bar mechanisms 242, 246 are moving at the same angle or are synchronous. There is no difference in displacements of the four-bar mechanism 242, 246 to cause the spherical mechanism to rotate the abduction spherical output about the axis C4. In this mode, the flexible output arm 220 is rotated about the axis C3. Through the compound motion plate 222, this rotation can be transferred to rotation of the abduction spherical output 214 about the axis C3. If an end effector is coupled to the abduction spherical output 214, the end effector will have a rotational position that depends on the rotational position of the flexible output arm 220 relative to the axis C3.

In Mode 2 of Table 2, the flexion input angle is 0, but the abduction input angle is nonzero, which means that the four-bar mechanisms 242, 246 are moving at different angles or asynchronously. The difference in displacements of the four-bar mechanisms 242, 246 will cause the spherical mechanism of the second mechanical linkage 212b to rotate the abduction spherical output 214 about the axis C4. Since the flexion input angle is 0, the resultant movement will not include flexion. If an end effector is coupled to the abduction spherical output 214, the end effector will have a rotational position that depends on the rotational position of the abduction spherical output 214 about the axis C4.

In Mode 3 of Table 3, both the flexion input angle and the abduction input angle are nonzero and unequal, which means that the four-bar mechanisms 242, 246 are moving at different angles or asynchronously. The difference in displacements of the four-bar mechanisms 242, 246 will cause the spherical mechanism of the second mechanical linkage 212b to rotate the abduction spherical output 214 about the axis C4. Since the flexion input angle is not equal to 0, the resultant movement will also include flexion. If an end effector is coupled to the abduction spherical output 214, the end effector will have a rotational position that depends on the rotation of the flexible output arm about the axis C3 (which affects the rotation of the abduction spherical output 214 about the axis C3) and rotation of the abduction spherical output about the axis C4.

### Example IV

### Example Method of Positioning an End Effector

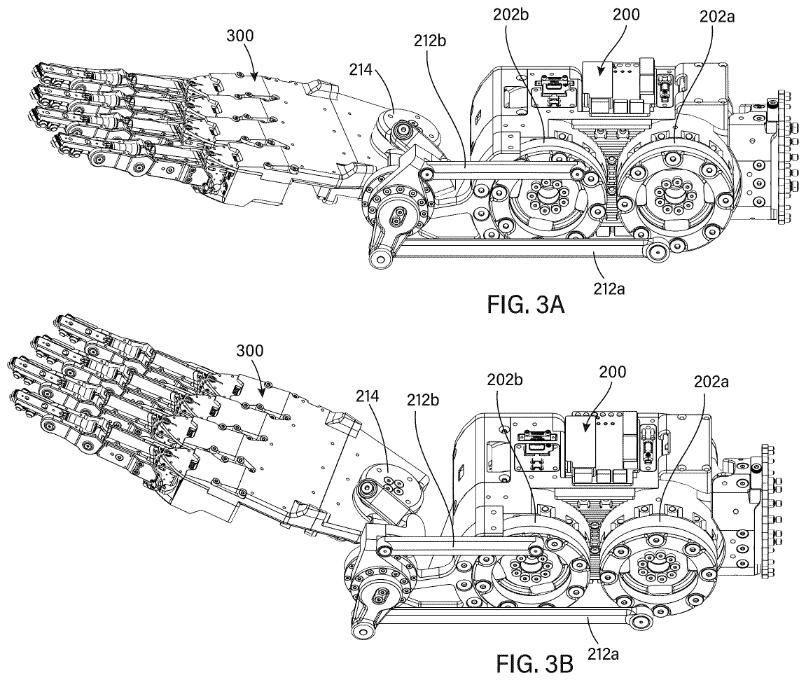

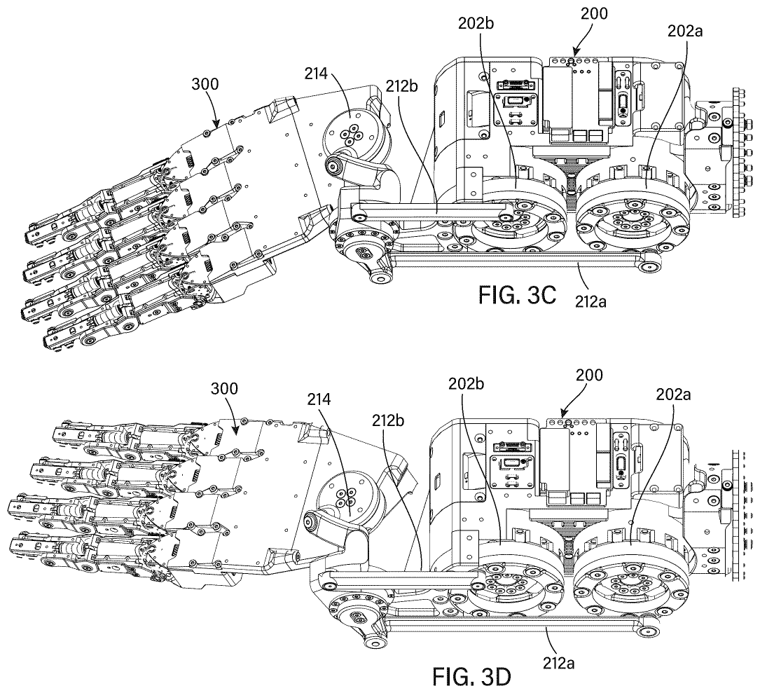

FIGS. 3A-3D show an end effector 300 coupled to the abduction spherical output 214 of the robotic wrist 200 such that movement of the abduction spherical output 214 can effect movement of the end effector. Not all the details of the end effector 300 are shown in FIGS. 3A-3D for simplicity.

A method for positioning the end effector 300 in a three-dimensional space can include receiving or accessing a target flexion angle and a target abduction angle for the end effector. For example, a controller associated with the robotic wrist 200 can receive a movement command for the end effector. The movement command can include the target values for flexion angle and abduction angle, or the target values for flexion angle and abduction angle can be determined from information contained in the movement command.

The method can include determining a flexion input angle based on the target flexion angle and an abduction input angle based on the target flexion angle and target abduction angle (as described in Example III). For example, if the target value for flexion angle is nonzero and the target value for abduction angle is zero, the desired movement can be determined to be pure flexion, and the values for flexion input angle and abduction input angle can be determined according to Mode 1 in Table 2 of Example III. In some examples, the controller for the robotic wrist 200 can determine the values for flexion input angle and abduction input angle.

The method can include determining an actuator position for the first actuator 202a based on the flexion input angle. The method can include determining an actuator position for the second actuator 202b based on the abduction input angle. For example, calibration functions that map the input angles of the four-bar mechanisms to the respective actuators can be used to determine the actuator positions.

The method can include controlling the actuators 202a, 202b to the respective determined actuator positions. For example, if the actuators 202a, 202b include servomotors, the actuator positions can be provided to the controls of the servomotors to effect controlling the actuators to the determined actuator positions. As the actuators move to the determined actuator positions, the mechanical linkages 212a, 212b, which are coupled to the outputs of the actuators 202a, 202b, will rotate the end effector 300 to the rotational positions indicated by the target flexion angle and target abduction angle. The end effector can be rotated about one or both of axis C3 and C4, depending on the target flexion angle and target abduction angle.

FIG. 3A shows the end effector 300 at an example position in which the flexion angle and the abduction angle have a minimum value Aₘᵢₙ. FIG. 3B shows the end effector 300 at an example position in which the flexion angle has a minimum value Aₘᵢₙ and abduction angle has a maximum value Aₘₐₓ. FIG. 3C shows the end effector 300 at an example position in which the flexion angle has a maximum value Aₘₐₓ and the abduction angle has a minimum value Aₘᵢₙ. FIG. 3E shows the end effector 300 at an example position in which the flexion angle has a maximum value Aₘₐₓ and the abduction angle has a maximum value Aₘₐₓ.

### Example V

### Method of Assembly of Robotic Wrist

FIG. 4 is an exploded view illustrating an example assembly of the functional components of the robotic wrist 200.

A method of assembling the robotic wrist 200 can include securing the abduction input 216b onto the output of the first actuator 202a of the dual actuator 202 (e.g., using shoulder bolts 286, 287). The method can include securing the flexion input 216a onto the output of the second actuator 202b of the dual actuator 202 (e.g., using shoulder bolts 286, 287).

The method can include pressing the bearing 224 into the opening in the compound motion plate 222. The method can include inserting an end portion of the abduction spherical output 214 into an inner diameter of the bearing 224, while ensuring that no axial motion of the bearing 224 occurs relative to the compound motion plate 222. The abduction hard stop 288 can be attached to the compound motion plate 222 (e.g., using one or more screws 289).

The method can include pressing the bearing 236 into an opening in the wrist frame 234. The method can include pressing the first end portion of the compound motion plate 222 into the inner diameter of the bearing 236, while ensuring that no axial motion of the bearing 236 occurs relative to the wrist frame 234. The method can include securing a flexion bearing plate 290 (see FIG. 2F) to the wrist frame 234 (e.g., using one or more screws 291). The method can include securing an inner bearing plate 292 (see FIG. 3F) to the front end portion of the compound motion plate 222 (e.g., using one or more screws 293).

The method can include pressing the bearing 238 into an opening in the spherical linkage input 232. The method can include pressing the first end portion of the compound motion plate 222 into the inner diameter of the bearing 238, while ensuring that no axial motion of the bearing 238 occurs relative to the wrist frame 234. The method can include securing an outer bearing plate 294 to the spherical linkage input 232 (e.g., using one or more screws 295). The method can include securing a flexion hard stop 385 to the wrist frame 234 (e.g., using one or more screws 212). The flexion hard stop 385 can act to limit flexion movement of the differential mechanism.

The method can include pressing cam followers 296, 297 into openings at the ends of the spherical link 240. The cam follower 296 can be secured to the abduction spherical output 214, forming a rotary joint between the abduction spherical output 214 and the spherical link 240. The cam follower 297 can be secured to the spherical linkage input 232, forming a rotary joint between the spherical linkage input 232 and the spherical link 240. The method can include fastening the wrist frame 234 to the housing of the dual actuator 202 (e.g., using one or more shoulder bolts 299).

The method can include pressing cam followers 281a, 281b into openings in end portions of the flexion link 218a and cam followers 283a, 283b into openings in the end portions of the abduction link 218b. The cam follower 281b can be secured to the flexion output arm 220 (e.g., the cam follower can include a threaded portion that engages a threaded hole in the flexion output arm 220), forming a rotary joint between the flexion output arm 220 and the flexion link 218a. The cam follower 281a can be secured to the flexion input 216a (e.g., the cam follower 281a can include a threaded portion that engages a threaded hole in the flexion input 216a), forming a rotary joint between the flexion input 216a and the flexion link 218a.

The method can include securing the flexion output arm 220 to the compound motion plate 222 (e.g., using shoulder screws 282). The method can include securing the cam follower 283a to the abduction input 216b and the cam follower 283b to the spherical linkage input 232.

### ADDITIONAL EXAMPLES

Additional examples based on principles described herein are enumerated below. Further examples falling within the scope of the subject matter can be configured by, for example, taking one feature of an example in isolation, taking more than one feature of an example in combination, or combining one or more features of one example with one or more features of one or more other examples.

### Example 1

A robotic wrist includes a wrist frame, a first actuator having a first actuator output, a second actuator having a second actuator output, a first mechanical linkage comprising a first input coupled to the first actuator output and a first output coupled to the wrist frame, a second mechanical linkage comprising a second input coupled to the second actuator output and a second output coupled to the wrist frame, wherein a rotational position of the first output about a first axis is responsive to a position of the first actuator output, and wherein a rotational position of the second output about a second axis that is transverse to the first axis is responsive to a difference between a position of the first actuator output and a position of the second actuator output.

### Example 2

A robotic wrist according to Example 1, which further includes a compound motion plate coupled to the wrist frame such that the compound motion plate is rotatable with the first output about the first axis.

### Example 3

A robotic wrist according to Example 2, wherein the second output is rotatably coupled to the compound motion plate such that the second output is rotatable relative to the compound motion plate about the second axis and rotatable with the compound motion plate about the first axis.

### Example 4

A robotic wrist according to any one of Examples 2-3, wherein the first actuator and the second actuator are disposed in a common housing, and wherein the wrist frame is attached to the common housing.

### Example 5

A robotic wrist according to Example 4, wherein the first actuator output defines a third axis, wherein the second actuator output defines a fourth axis, and wherein the first actuator and the second actuator are oriented within the housing such that the third axis and the fourth axis are parallel.

### Example 6

A robotic wrist according to Example 5, wherein an axial axis of the compound motion plate is aligned with the first axis, and wherein the first axis is parallel to the third axis and the fourth axis.

### Example 7

A robotic wrist according to any one of Examples 1-6, wherein the first mechanical linkage comprises a first four-bar linkage, and wherein the second mechanical linkage comprises a second four-bar linkage.

### Example 8

A robotic wrist according to Example 7, wherein the second mechanical linkage further comprises a spherical linkage coupled to the second four-bar linkage, and wherein the spherical linkage includes the second output.

### Example 9

A robotic wrist according to any one of Examples 1-8, wherein the second output comprises an attachment interface for an end effector.

### Example 10

A robotic arm includes a plurality of arm segments coupled together in series. A first arm segment of the plurality of arm segments includes a frame, a first actuator having a first actuator output, a second actuator having a second actuator output, a first mechanical linkage comprising a first input coupled to the first actuator output and a first output coupled to the frame, and a second mechanical linkage comprising a second input coupled to the second actuator output and a second output coupled to the frame, wherein a rotational position of the first output about a first axis is responsive to a position of the first actuator output, and wherein a rotational position of the second output about a second axis that is transverse to the first axis is responsive to a difference between a position of the first actuator output and a position of the second actuator output.

### Example 11

A robotic arm according to Example 10, wherein the first actuator and the second actuator are disposed within a common housing, and wherein the frame is attached to the common housing.

### Example 12

A robotic arm according to Example 11, which further includes an attachment interface for an end effector coupled to the second output and an attachment interface for an arm segment coupled to the common housing.

### Example 13

A robotic arm according to any one of Examples 11-12, further includes a compound motion plate coupled to the frame such that the compound motion plate is rotatable with the first output about the first axis.

### Example 14

A robotic arm according to Example 13, wherein the first actuator output defines a third axis, wherein the second actuator output defines a fourth axis, wherein the compound motion plate defines the first axis, and wherein the first actuator, the second actuator, and the compound motion plate are oriented such that the third axis, the fourth axis, and the first axis are parallel.

### Example 15

A robotic arm according to any one of Examples 10-14, wherein the first mechanical linkage comprises a first four-bar linkage, wherein the second mechanical linkage comprises a second four-bar linkage coupled to a spherical linkage, wherein the second four-bar linkage comprises the second input, and wherein the spherical linkage comprises the second output.

### Example 16

A robot includes a robot torso, an end effector, and a robotic arm coupled to the robot torso and the end effector. The robotic arm includes a robotic wrist. The robotic wrist includes a wrist frame, a first actuator having a first actuator output, a second actuator having a second actuator output, a first mechanical linkage comprising a first input coupled to the first actuator and a first output coupled to the wrist frame, a second mechanical linkage comprising a second input coupled to the second actuator output and a second output coupled to the wrist frame and the end effector, wherein a rotational position of the first output about a first axis is responsive to a position of the first actuator output, and wherein a rotational position of the second output about a second axis that is transverse to the first axis is responsive to a difference between a position of the first actuator output and a position of the second actuator output.

### Example 17

A robotic wrist includes a wrist frame, a first actuator having a first actuator output defining a first axis, a second actuator having a second actuator output defining a second axis, a first differential input coupled to the first actuator output and rotatable about the first axis in response to motion of the first actuator output, a second differential input coupled to the second actuator output and rotatable about th second axis in response motion of the second actuator output, a first differential output coupled to the wrist frame and rotatably supported about a third axis, a second differential output coupled to the wrist frame and rotatably supported about the third axis and a fourth axis that is transverse to the third axis, a first link set coupling the first differential input to the first differential output, and a second link set coupling the second differential input to the second differential output, wherein a rotational position of the first differential output about the third axis is responsive to a rotational position of the first differential input about the first axis, and wherein a rotational position of the second differential output about the fourth axis is responsive to a difference between a rotational position of the first differential input about the first axis and a rotational position of the second differential input about the second axis.

### Example 18

A robotic wrist according to Example 17, wherein the first link set comprises a first link having a first end portion coupled to the first differential input by a first rotary joint and a second end portion coupled to the first differential output by a second rotary joint.

### Example 19

A robotic wrist according to Example 18, wherein the second link set comprises a spherical link having a first end portion coupled to the second differential output by a third rotary joint.

### Example 20

A robotic wrist according to Example 19, wherein the second link set further comprises a second link having a first end portion coupled to the second differential input by a fourth rotary joint, wherein the second link is parallel to the first link.

### Example 21

A robotic wrist according to Example 20, wherein the second link set further comprises a spherical linkage input having a first end portion coupled to a second end portion of the spherical link by a fifth rotary joint and a second end portion coupled to a second end portion of the second link by a sixth rotary joint.

### Example 22

A robotic wrist according to Example 21, wherein the spherical linkage input is rotatably supported about the third axis.

### Example 23

A robotic wrist according to any one of Examples 18-22, wherein each of the rotary joints comprises a cam follower.

### Example 24

A robotic wrist according to Example 17, wherein the first actuator and the second actuator are disposed in a common housing.

### Example 25

A robotic wrist according to Example 24, wherein the first actuator and the second actuator are oriented within the common housing such that the first axis and the second axis are parallel.

### Example 26

A robotic wrist according to Example 25, which further includes a compound motion plate axially aligned with the third axis and rotatably coupled to the wrist frame, wherein the first differential output is fixedly coupled to a first end portion of the compound motion plate, and wherein the second differential output is rotatably coupled to a second end portion of the compound motion plate.

### Example 27

A robotic wrist according to Example 26, which further includes a first mechanical stop member attached to the compound motion plate and arranged to limit a rotational range of the second differential output about the fourth axis.

### Example 28

A robotic wrist according to Example 26, which further includes a second mechanical stop member attached to the compound motion plate and arranged to limit a rotational range of the first differential output about the third axis.

### Example 29

A robotic wrist according to any one of Examples 24-28, which further includes an attachment interface for a robotic arm segment coupled to the common housing.

### Example 30

A robotic wrist according to any one of Examples 17-29, wherein the second differential output comprises an attachment interface for an end effector.

### Example 31

A robotic arm includes a plurality of arm segments coupled together in series by movable joints, wherein a first arm segment of the plurality of arm segments comprises a frame, a first actuator having a first actuator output defining a first axis, a second actuator having a second actuator output defining a second axis, a first differential input coupled to the first actuator output and rotatable about the first axis in response to motion of the first actuator output, a second differential input coupled to the second actuator output and rotatable about the second axis in response motion of the second actuator output, a first differential output coupled to the frame and rotatably supported about a third axis, a second differential output coupled to the frame and rotatably supported about the third axis and a fourth axis that is transverse to the third axis, a first link set coupling the first differential input to the first differential output, a second link set coupling the second differential input to the second differential output, wherein a rotational position of the first differential output about the third axis is responsive to a rotational position of the first differential input about the first axis, and wherein a rotational position of the second differential output about the fourth axis is responsive to a difference between a rotational position of the first differential input about the first axis and a rotational position of the second differential input about the second axis.

### Example 32

A robotic arm according to Example 31, wherein the first link set comprises a first link having a first end portion coupled to the first differential input by a first rotary joint and a second end portion coupled to the first differential output by a second rotary joint.

### Example 33

A robotic arm according to Example 32, wherein the second link set comprises a spherical link having a first end portion coupled to the second differential output by a third rotary joint.

### Example 34

A robotic arm according to Example 33, wherein the second link set further comprises a second link having a first end portion coupled to the second differential input by a fourth rotary joint, wherein the second link is parallel to the first link.

### Example 35

A robotic arm according to Example 34, wherein the second link set further comprises a spherical linkage input having a first end portion coupled to a second end portion of the spherical link by a fifth rotary joint and a second end portion coupled to a second end portion of the first link by a sixth rotary joint.

### Example 36

A robotic arm according to Example 35, wherein the spherical linkage input is pivotably supported about the third axis.

### Example 37

A robotic arm according to any one of Examples 31-36, wherein the first actuator and the second actuator comprise rotary actuators.

### Example 38

A robotic arm according to Example 37, wherein the first actuator and the second actuator are oriented such that the first axis and the second axis are parallel.

### Example 39

A robotic arm according to any one of Examples 37-38, wherein the first actuator and the second actuator are disposed in a common housing.

### Example 40

A robotic arm according to Example 39, which further includes a compound motion plate axially aligned with the third axis and rotatably coupled to the frame, wherein the first differential output is fixedly coupled to a first end portion of the compound motion plate, and wherein the second differential output is rotatably coupled to a second end portion of the compound motion plate.

### Example 41

A robotic arm according to Example 40, which further includes a first mechanical stop member coupled to the compound motion plate and arranged to limit a rotational range of the second differential output about the fourth axis.

### Example 42

A robotic arm according to Example 41 which further includes a second mechanical stop member coupled to the compound motion plate and arranged to limit a rotational range of the first differential output and the second differential output about the third axis.

### Example 43

A robotic arm according to any one of Examples 39-42, which further includes an attachment interface for an arm segment coupled to the common housing.

### Example 44

A robotic arm according to any one of Examples 31-43, wherein the second differential output comprises an attachment interface for an end effector.

### Example 45

A robot includes a robot torso and a robotic arm coupled to the robot torso. The robotic arm includes a plurality of arm segments coupled together in series by movable joints. A first arm segment of the plurality of arm segments includes a frame, a first actuator having a first actuator output defining a first axis, a second actuator having a second actuator output defining a second axis, a first differential input coupled to the first actuator output and rotatable about the first axis in response to motion of the first actuator output, a second differential input coupled to the second actuator output and rotatable about the second axis in response motion of the second actuator output, a first differential output coupled to the frame and rotatably supported about a third axis, a second differential output coupled to the frame and rotatably supported about the third axis and a fourth axis that is transverse to the third axis, a first link set coupling the first differential input to the first differential output, and a second link set coupling the second differential input to the second differential output, wherein a rotational position of the first differential output about the third axis is responsive to a rotational position of the first differential input about the first axis, and wherein a rotational position of the second differential output about the fourth axis is responsive to a difference between a rotational position of the first differential input about the first axis and a rotational position of the second differential input about the second axis.

### Example 46

A method of positioning an end effector in a three-dimensional space includes receiving or accessing a first target rotational position of the end effector relative to a first axis, receiving or accessing a second target rotational position of the end effector relative to a second axis that is transverse to the first axis, determining a first position for a first actuator output coupled to an input of a mechanical linkage based on the first target rotational position, wherein an output of the mechanical linkage is coupled to the end effector, determining a second position for a second actuator output coupled to an input of a second mechanical linkage based on a difference between the first target rotational position and the second target rotational position, wherein an output of the second mechanical linkage is coupled to the end effector, and controlling the first actuator and the second actuator to the respective first actuator position and second actuator position to rotate the end effector to the first target rotational position about the first axis and the second target rotational position about the second axis.

### Example 47

A robotic wrist includes a wrist frame, a first actuator having a first actuator output, a second actuator having a second actuator output, a first mechanical linkage comprising a first input coupled to the first actuator output and a first output coupled to the wrist frame, and a second mechanical linkage comprising a second input coupled to the second actuator output and a second output coupled to the wrist frame. The first mechanical linkage includes a first four-bar linkage. The second mechanical linkage includes a second four-bar linkage and a spherical linkage coupled to the second four-bar linkage.

1. A robotic wrist comprising:
a wrist frame;
a first actuator having a first actuator output;
a second actuator having a second actuator output;
a first mechanical linkage comprising a first input coupled to the first actuator output and a first output coupled to the wrist frame;
a second mechanical linkage comprising a second input coupled to the second actuator output and a second output coupled to the wrist frame;
wherein a rotational position of the first output about a first axis is responsive to a position of the first actuator output; and
wherein a rotational position of the second output about a second axis that is transverse to the first axis is responsive to a difference between a position of the first actuator output and a position of the second actuator output.

2. The robotic wrist of claim 1, further comprising a compound motion plate coupled to the wrist frame such that the compound motion plate is rotatable with the first output about the first axis.

3. The robotic wrist of claim 2, wherein the second output is rotatably coupled to the compound motion plate such that the second output is rotatable relative to the compound motion plate about the second axis and rotatable with the compound motion plate about the first axis.

4. The robotic wrist of claim 2, wherein the first actuator and the second actuator are disposed in a common housing, and wherein the wrist frame is attached to the common housing.

5. The robotic wrist of claim 4, wherein the first actuator output defines a third axis, wherein the second actuator output defines a fourth axis, and wherein the first actuator and the second actuator are oriented within the housing such that the third axis and the fourth axis are parallel.

6. The robotic wrist of claim 5, wherein an axial axis of the compound motion plate is aligned with the first axis, and wherein the first axis is parallel to the third axis and the fourth axis.

7. The robotic wrist of claim 1, wherein first mechanical linkage comprises a first four-bar linkage, and wherein the second mechanical linkage comprises a second four-bar linkage.

8. The robotic wrist of claim 7, wherein the second mechanical linkage further comprises a spherical linkage coupled to the second four-bar linkage, and wherein the spherical linkage includes the second output.

9. The robotic wrist of claim 1, wherein the second output comprises an attachment interface for an end effector.

10. A robotic arm comprising:
a plurality of arm segments coupled together in series, wherein a first arm segment of the plurality of arm segments comprises:
a frame;
a first actuator having a first actuator output;
a second actuator having a second actuator output;
a first mechanical linkage comprising a first input coupled to the first actuator output and a first output coupled to the frame;
a second mechanical linkage comprising a second input coupled to the second actuator output and a second output coupled to the frame;
wherein a rotational position of the first output about a first axis is responsive to a position of the first actuator output; and
wherein a rotational position of the second output about a second axis that is transverse to the first axis is responsive to a difference between a position of the first actuator output and a position of the second actuator output.

11. The robotic arm of claim 10, wherein the first actuator and the second actuator are disposed within a common housing, and wherein the frame is attached to the common housing.

12. The robotic arm of claim 11, further comprising an attachment interface for an end effector coupled to the second output and an attachment interface for an arm segment coupled to the common housing.

13. The robotic arm of claim 11, further comprising a compound motion plate coupled to the frame such that the compound motion plate is rotatable with the first output about the first axis.

14. The robotic arm of claim 13, wherein the first actuator output defines a third axis, wherein the second actuator output defines a fourth axis, wherein the compound motion plate defines the first axis, and wherein the first actuator, the second actuator, and the compound motion plate are oriented such that the third axis, the fourth axis, and the first axis are parallel.

15. The robotic arm of claim 10, wherein the first mechanical linkage comprises a first four-bar linkage, wherein the second mechanical linkage comprises a second four-bar linkage coupled to a spherical linkage, wherein the second four-bar linkage comprises the second input, and wherein the spherical linkage comprises the second output.

16. A robot comprising:
a robot torso;
a robotic arm coupled to the robot torso, the robotic arm comprising a robotic wrist, wherein the robotic wrist comprises:
a wrist frame;
a first actuator having a first actuator output;
a second actuator having a second actuator output;
a first mechanical linkage comprising a first input coupled to the first actuator output and a first output coupled to the wrist frame;
a second mechanical linkage comprising a second input coupled to the second actuator output and a second output coupled to the wrist frame;
wherein a rotational position of the first output about a first axis is responsive to a position of the first actuator output; and
wherein a rotational position of the second output about a second axis that is transverse to the first axis is responsive to a difference between a position of the first actuator output and a position of the second actuator output.

17. The robot of claim 16, wherein the second output comprises an attachment interface for the end effector, and further comprising an end effector coupled to the robotic wrist at the attachment interface.

18. The robot of claim 16, wherein the first actuator and the second actuator are disposed within a common housing, and wherein the wrist frame is attached to the common housing.

19. The robot of claim 16, wherein the first mechanical linkage comprises a first four-bar linkage, wherein the second mechanical linkage comprises a second four-bar linkage coupled to a spherical linkage, wherein the second four-bar linkage comprises the second input, and wherein the spherical linkage comprises the second output.

20. A method of positioning an end effector in a three-dimensional space, the method comprising:
receiving or accessing a first target rotational position of the end effector relative to a first axis;
receiving or accessing a second target rotational position of the end effector relative to a second axis that is transverse to the first axis;
determining a first actuator position for a first actuator having a first actuator output coupled to an input of a first mechanical linkage based on the first target rotational position, wherein an output of the first mechanical linkage is coupled to the end effector;
determining a second actuator position for a second actuator having a second actuator output coupled to an input of a second mechanical linkage based on a difference between the first rotational position and the second rotational position, wherein an output of the second mechanical linkage is coupled to the end effector; and
controlling the first actuator and the second actuator to the respective first actuator position and second actuator position to rotate the end effector to the first target rotational position about the first axis and the second target rotational position about the second axis.
